(19) United States
(12) Patent Application Publication
(10) Pub. No.: US 2026/0304375 A1
(43) Pub. Date: Oct. 1, 2026

(54) METHOD AND DEVICE FOR DETECTING AND/OR TRACKING SENSING TARGETS

(71) Applicant: THE HONG KONG POLYTECHNIC UNIVERSITY, Hong Kong (CN)

(72) Inventors: Liang LIU, Hong Kong (CN); Chao LU, Hong Kong (CN); Pak Tao LAU, Hong Kong (CN)

(21) Appl. No.: 19/567,451

(22) Filed: Mar. 16, 2026

Related U.S. Application Data
(60) Provisional application No. 63/780,775, filed on Mar. 31, 2025.

(51) Int. Cl. H04W 64/00; G01H 9/00

(52) U.S. Cl. CPC H04W 64/003; G01H 9/004

(57) ABSTRACT

A computer-implemented method at a centralized office (CO), where the CO is configured to operate a centralized radio access network (C-RAN) adapted for integrated sensing and communication (ISAC) and the C-RAN includes a distribution of active antenna units (AAUs) coupled via a network of optical fibers, is provided. Steps of the method are: sensing, based on distributed acoustic sensing (DAS) via the network of optical fibers, at least one sensing target to determine an approximate location thereof defined with reference to a section of at least one optical fiber in the network of optical fibers; activating, based on the approximate location, at least one AAU in the AAUs configured to communicate millimeter-wave (mmWave) signals for detecting the sensing target, where the at least one AAU is proximal to the approximate location; and sensing, based on the communicated mmWave signals, to determine a 3-dimensional position of the sensing target.

### CROSS REFERENCE TO RELATED APPLICATIONS

The present application claims priority to Provisional Application No. 63/780,775 filed in the U.S. Patent and Trademark Office on Mar. 31, 2025, the entire contents of which are incorporated herein by reference.

### FIELD OF INVENTION

The following relates generally to integrated sensing and communication (ISAC), and more specifically, it relates to a method and a device for detecting and/or tracking sensing targets.

### BACKGROUND

Future radio access networks (RANs) will not only deliver high-quality radio communication, but also enable sensing functionalities, typically referred to as integrated sensing and communication (ISAC). The shift from distributed RAN (D-RAN) to centralized RAN (C-RAN) involves deployment of numerous optical fibers connecting central offices (COs) to remote radio units (RRUs). Optical fibers may also unlock their ISAC potential to support large-scale distributed sensing functionalities embedded within fronthaul. These capabilities may extend across expansive RANs deployed in urban environments, significantly enhancing network intelligence.

Previous studies have demonstrated numerous sensing capabilities via communication channels or techniques, including ISAC in wireless communication and ISAC in optical fiber communication (e.g. via distributed acoustic sensing (DAS)). These conventional solutions typically achieve integration within a system through dimensional multiplexing or by incorporating additional sensing devices. However, the sensing functionality implemented within a deployed communication network should preferably remain communication-centric, with sensing serving as an auxiliary function, ideally without substantially consuming communication resources.

Hence, there exists a need for a solution that may address at least one of the problems of the prior art, and/or to provide a choice that is useful in the art.

### SUMMARY

The described techniques herein may relate to a method and a device for detecting and/or tracking sensing targets.

According to a 1^{st} aspect, there is disclosed a computer-implemented method at a centralized office (CO), wherein the CO is configured to operate a centralized radio access network (C-RAN) that is adapted for integrated sensing and communication (ISAC) and the C-RAN includes a distribution of active antenna units (AAUs) coupled via a network of optical fibers, the method comprises: sensing, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target; activating, based on the approximate location, at least one AAU in the AAUs configured to communicate millimeter-wave (mmWave) signals for detecting the sensing target, wherein the at least one AAU is proximal to the approximate location; and sensing, based on the communicated mmWave signals, to determine a 3-dimensional (3D) position of the sensing target, wherein the approximate location and the 3D position collectively permit distinguishing and detecting of the sensing target.

Additionally or alternatively, the AAUs may be configured for 5G New Radio (NR) and/or 6G wireless communications.

Additionally or alternatively, each AAU in the AAUs may be arranged with mmWave phased arrays (PAs).

Additionally or alternatively, for determining the 3D position of the sensing target, the at least one AAU includes two AAUs which may comprise a first AAU configured to transmit the mmWave signals, and a second AAU configured to receive the transmitted mmWave signals.

Additionally or alternatively, the mmWave signals may be transmitted in a scanning range of substantially 5° by 5°.

Additionally or alternatively, the first AAU may be configured to control an angle of departure (AOD) of the mmWave signals transmitted at the sensing target; and the second AAU may be configured to estimate an angle of arrival (AOA) of mmWave signals received at the second AAU, the received mmWave signals being the transmitted mmWave signals reflected by the sensing target.

Additionally or alternatively, the AOA may be estimated with one of: a) minimum variance distortion-less response (CAPON); b) iterative adaptive approach (IAA); and c) multiple signal classification (MUSIC).

Additionally or alternatively, the determined approximate location may be represented as one-dimensional (1D) information.

Additionally or alternatively, the DAS may be configured based on phase-sensitive optical time-domain reflectometry (φ-OTDR).

Additionally or alternatively, the DAS may include linear frequency modulated (LFM) DAS (LFM-DAS) sensing.

Additionally or alternatively, the mmWave signals may be in the form of orthogonal frequency division multiplexing (OFDM) communication signals.

Additionally or alternatively, the OFDM communication signals may be in the Ka-band.

Additionally or alternatively, the spectral signature of the sensing target may include an acoustic spectral of the sensing target.

Additionally or alternatively, the at least one sensing target may include a plurality of sensing targets.

According to a 2^{nd} aspect, there is disclosed a computing device at a centralized office (CO), wherein the CO is configured to operate a centralized radio access network (C-RAN) that is adapted for integrated sensing and communication (ISAC) and the C-RAN includes a distribution of active antenna units (AAUs) coupled via a network of optical fibers, the device comprises: one or more memories having executable code; and one or more processors coupled to the one or more memories, and configured to execute the code to cause the device to: sense, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target; activate, based on the approximate location, at least one AAU in the AAUs configured to communicate millimeter-wave (mmWave) signals for detecting the sensing target, wherein the at least one AAU is proximal to the approximate location; and sense, based on the communicated mmWave signals, to determine a 3-dimensional (3D) position of the sensing target, wherein the approximate location and the 3D position collectively permit distinguishing and detecting of the sensing target.

Additionally or alternatively, for determining the 3D position of the sensing target, the at least one AAU includes two AAUs which may comprise a first AAU configured to transmit the mmWave signals, and a second AAU configured to receive the transmitted mmWave signals.

Additionally or alternatively, the mmWave signals may be transmitted in a scanning range of substantially 5° by 5°.

Additionally or alternatively, the first AAU may be configured to control an angle of departure (AOD) of the mmWave signals transmitted at the sensing target; and the second AAU may be configured to estimate an angle of arrival (AOA) of mmWave signals received at the second AAU, the received mmWave signals being the transmitted mmWave signals reflected by the sensing target.

Additionally or alternatively, the AOA may be estimated with one of: a) minimum variance distortion-less response (CAPON); b) iterative adaptive approach (IAA); and c) multiple signal classification (MUSIC).

According to a 3^{rd} aspect, there is disclosed a non-transitory computer-readable medium comprising executable code, which when executed by a processor of a computing device at a centralized office (CO), cause the processor to perform the method of the 1^{st} aspect.

Additional benefits and advantages of the disclosed aspects may become apparent from the specification and drawings. The benefits and/or advantages may be individually obtained by the various aspects and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to illustrate various aspects and to explain various principles and advantages in accordance with the present disclosure.

FIG. 1a is an example scenario, whereby integrated sensing and communication (ISAC) is enabled in a centralized radio access network (C-RAN) via a 5G optical fiber-based mobile fronthaul and phased array (PA)-based active antenna units (AAUs), in accordance with aspects of the present disclosure.

FIG. 1b is a table comparing respective parameters typically adopted for Rayleigh backscattering-based (RBS-based) optical fiber sensing and millimeter-wave-based (mmWave-based) wireless sensing, in accordance with aspects of the present disclosure.

FIG. 2 is a flowchart illustrating a method at a centralized office (CO) for detecting and/or tracking sensing targets, in accordance with aspects of the present disclosure.

FIG. 3a is an example mmWave optical fiber-wireless ISAC setup for detecting and/or tracking sensing targets, in accordance with aspects of the present disclosure.

FIG. 3b is an example mmWave setup used in the ISAC setup of FIG. 3a, in accordance with aspects of the present disclosure.

FIGS. 3c to 3l are respective calibration of results obtained from the ISAC setup of FIG. 3a using different algorithms, in accordance with aspects of the present disclosure, wherein:

FIG. 3c depicts results of DD-MAM spectrum;

FIG. 3d depicts results of 60° AOA;

FIG. 3e depicts results of 80° AOA;

FIG. 3f depicts results of 100° AOA;

FIG. 3g depicts results of 120° AOA;

FIG. 3h depicts results of AOD scan;

FIG. 3i depicts results of PDoA;

FIG. 3j depicts results of CAPON;

FIG. 3k depicts results of IAA; and

FIG. 3l depicts results of MUSIC.

FIGS. 4a to 4f are respective results obtained from joint fiber-wireless sensing, in accordance with aspects of the present disclosure, wherein:

FIG. 4a depicts results that show a detected vibration event along the SMF, and its corresponding short-time Fourier transform (STFT) spectrogram;

FIG. 4b depicts a range-AOA diagram for providing a complete 3D localization information of a vibrating object using AOD-range-AOA;

FIG. 4c depicts a reconstructed 3D position of the vibrating object;

FIG. 4d depicts a DAS waterfall plot, which indicates a distinct soundtrack at the same location but fails to provide further details due to multiple-object aliasing;

FIG. 4e depicts a range-AOA diagram, which reveals the presence of three distinct objects for a specific AOD; and

FIG. 4f depicts a reconstructed 3D position after completing the AOD-ranging-AOA process, showing that the reconstructed 3D position aligns well with the actual object placement.

FIGS. 4g to 4h respectively depict results of communication performance vis-à-vis joint fiber-wireless sensing, in accordance with aspects of the present disclosure, wherein:

FIG. 4g depicts the recovered constellation of a PS-4096-QAM-OFDM signal transmitted with entropy ranging from 10 to 12; and

FIG. 4h plots the normalized generalized mutual information (NGMI) measured as a function of entropy.

FIG. 5 is a block diagram of a first device for detecting and/or tracking sensing targets, in accordance with aspects of the present disclosure.

FIG. 6 is a block diagram of a second device for detecting and/or tracking sensing targets, in accordance with aspects of the present disclosure.

FIG. 7 is a block diagram of a communications manager for detecting and/or tracking sensing targets, in accordance with aspects of the present disclosure.

FIG. 8 is a schematic diagram of an exemplary computing device for performing the method of FIG. 2, in accordance with aspects of the present disclosure.

FIG. 9 is a schematic diagram of an exemplary computing device for performing the method of FIG. 2, in accordance with aspects of the present disclosure.

### DETAILED DESCRIPTION

Some portions of the description which follows below are explicitly or implicitly presented in terms of algorithms and functional or symbolic representations of operations on data within a computer memory. These algorithmic descriptions and functional or symbolic representations are the means used by those skilled in the data processing arts to effectively convey the substance of their work to other practitioners skilled in the art. An algorithm is generally conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present disclosure, discussions utilizing terms such as “scanning”, “calculating”, “determining”, “replacing”, “generating”, “initializing”, “outputting”, or the like, may refer to the action and processes of a computer system, or similar electronic device, that manipulates and/or transforms data represented as physical quantities within the computer system into other data similarly represented as physical quantities within the computer system or other information storage, transmission or display devices.

The present disclosure also discloses apparatus/device for performing the operations of the methods. Such apparatus/device may specially be constructed or arranged for the required purposes, or may comprise a computer or other device selectively activated or reconfigured by a computer program stored in the computer. The algorithms and displays presented herein are not inherently related to any particular computer or other apparatus. Various machines may be used with computer programs in accordance with the teachings herein. Alternatively, the construction of specialized apparatus to perform the method steps may also be appropriate, depending on circumstances. The structure of a conventional computer is also described below for completeness.

Further, the present disclose also implicitly discloses a computer program, in that it may be apparent to a person skilled in the art that the individual steps of the method described herein may be put into effect by computer code/instructions. The computer program is not intended to be limited to any particular programming language and implementation thereof. It is highlighted that a variety of programming languages and coding thereof may be used to implement the teachings of the disclosure contained herein. Moreover, the computer program is not intended to be limited to any particular control flow. There may be numerous other variants of the computer program, which use different control flows, without departing from the spirit or scope of the present disclosure.

Furthermore, one or more of the steps of the computer program may be performed in parallel, as opposed to sequentially. Such a computer program may be stored on any computer readable medium. The computer readable medium may include storage devices such as magnetic/optical disks, memory chips, or other storage devices suitable for interfacing with a general-purpose computer. The computer-readable medium may also include a hard-wired medium such as exemplified by the Internet system, or wireless medium such as exemplified by the GSM, GPRS, 3G, 4G, 5G, NR mobile communication systems, as well as other wireless communication systems/standards such as Bluetooth, ZigBee, or Wi-Fi. The computer program, which when loaded and executed on such a computer effectively results in an apparatus that implements aspect(s) of the present disclosure.

Aspect(s) of the present disclosure may also be implemented as associated hardware modules. More particularly, in the hardware context, a module is a functional hardware unit designed for use with other components or modules. For example, a module may be implemented using discrete electronic components, or it may form a portion of an entire electronic circuit such as an Application Specific Integrated Circuit (ASIC) or Field Programmable Gate Array (FPGA). Numerous other possibilities exist, as known in the art. Persons skilled in the art may also appreciate that the system is implementable via a combination of hardware and software modules.

Aspects of the present disclosure provide a (computer-implemented) method and a corresponding device for detecting and/or tracking sensing targets. The discussions below set out the disclosed subject matter, in accordance with various aspects of the present disclosure.

For completeness, it is to be appreciated that the term “sensing target” (or “target object”) may be understood as a physical object or entity to be detected and/or tracked, and some examples are provided below. In the present disclosure, to detect may mean to detect the presence of a sensing target, and to track may mean to continuously monitor and follow the movement or location of the sensing target, e.g. with the goal of predicting a future position or behavior of the sensing target.

The techniques described herein may be used for various wireless networks and radio technologies. While aspects may be described herein using terminology commonly associated with 3G, 4G, and/or new radio (e.g. 5G NR) wireless technologies, aspects of the present disclosure can be applied in other (future) generation-based communication systems (e.g. 6G-based) configured for MU-MIMO transmissions.

### Introduction

In accordance with the present disclosure, an integrated 5G NR communication and 3-dimensional (3D) sensing system (with a corresponding method) is proposed, which is configured to utilize both distributed acoustic sensing (DAS) and millimeter-wave (mmWave) wireless sensing. For referencing convenience, the proposed sensing system is hereinafter referred to as the “proposed ISAC system”.

Based on the present disclosure, it is proposed to combine DAS and mmWave sensing to complement each other: DAS may provide extra knowledge on approximate locations of sensing objects, allowing a central office (CO) to dispatch only the nearest phased arrays (PAs) for more detailed wireless sensing of the sensing objects, while keeping the other PAs in communication mode with mmWave signals.

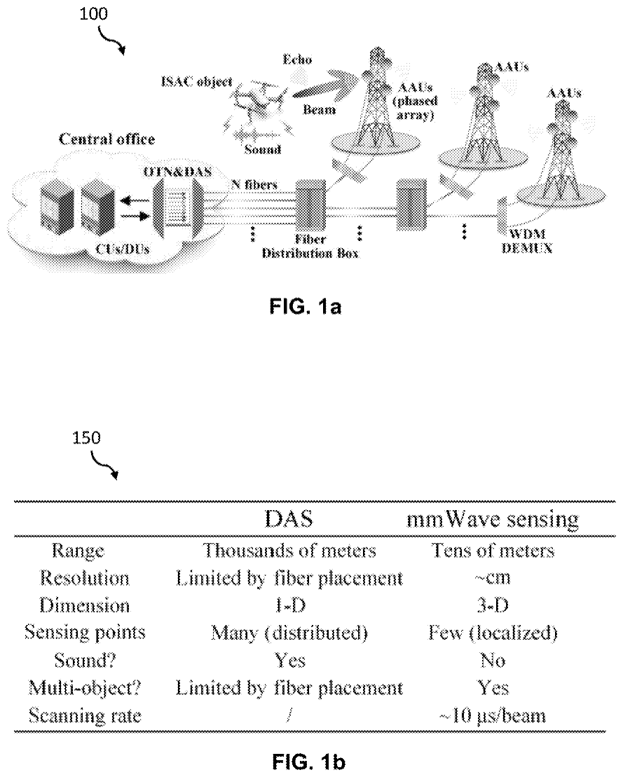

For the proposed ISAC system, the CO is configured to operate a centralized radio access network (C-RAN) that is adapted for integrated sensing and communication (ISAC) and the C-RAN includes a distribution of active antenna units (AAUs) coupled via a network of optical fibers. In connection, FIG. 1a is an example scenario 100, whereby ISAC is enabled in the C-RAN via a 5G optical fiber-based mobile fronthaul and PA-based AAUs. The AAUs are each configured with at least one mmWave PA, and are configured to output mmWave signals in the Ka-band. The mmWave signals may be orthogonal frequency division multiplexing (OFDM) communication signals, which may be compatible with 5G/6G-based communications, that are secondarily exploited for ISAC purposes, according to aspects of the present disclosure.

Accordingly, the scanning angles along both the horizontal and vertical axes may be reduced from 180°×180° to just a few degrees, thereby significantly increasing the sensing speed of the PA. Specifically, based on the present disclosure, it is demonstrated that a new integrated ISAC paradigm combining optical fiber-based DAS and mmWave ISAC techniques, leveraging the characteristics of the deployed structure of the C-RAN, is possible. The proposed ISAC system may enable drone detection and localization with 1000× times improvement in scanning speed, without compromising communication performance, proving potential benefits in safety monitoring of smart city and operation efficiency in emerging low-altitude economies. Moreover, the proposed ISAC system also demonstrates advantages of using communication signals per se for the sensing purposes, and identifies that the C-RAN may provide a promising platform for enabling interaction between wireless and optical fiber-based ISAC systems for detecting and/or tracking sensing targets.

### Complementarity Between Fiber Sensing and Wireless Sensing

DAS typically has a sensing range of over tens of kilometers, and has a theoretical sensing resolution at millimeter-level precision. Further, DAS is highly sensitive to vibrations and their associated spectral information, which may enable efficient event detection. However, the practical sensing resolution of DAS is constrained by factors such as field fiber placement, and source directionality. While specialized fiber placement or event classification algorithms may provide spatial information of a source of vibration, general DAS implementations are typically limited to 1-dimension (1D) sensing, and are unable to detect multiple adjacent 3D objects (also known as the multi-source aliasing problem).

On the other hand, due to the substantively large bandwidth and antenna array provided by 5G/6G-based networks, mmWave sensing by 5G/6G ISAC systems may perform target sensing with high range and angle resolutions. By extracting range and angle information about a sensing object from channel state information (CSI), it is then possible to obtain the 3D positions of multiple sensing objects. However, mmWave sensing typically suffers from limited range, low scanning rate, and may significantly consume communication resources. Establishing a large-scale sensing network with mmWave sensing per se may cause heavy resource utilization.

Through beamforming and scanning using PAs, mmWave sensing in 5G/6G ISAC systems may measure both the range and angle of multiple sensing targets. By leveraging an angle of departure (AOD) and an angle of arrival (AOA) estimation, it is possible to obtain respective 3D positions of the multiple sensing targets. However, mmWave sensing has limited range, low scanning rate, and significantly consumes communication resources. Establishing a large-scale sensing network with mmWave sensing alone may result in heavy resource utilization. Comparison between respective parameters typically adopted for Rayleigh backscattering-based (RBS-based) optical fiber sensing and millimeter-wave-based (mmWave-based) wireless sensing is summarized at table 150 in FIG. 1b. As illustrated in FIG. 1a, optical fibers connecting to the AAUs may enable a vast, distributed sensing network with all information processed at the CO. When used in conjunction with wireless sensing, DAS may provide valuable positioning information, distinguish objects based on their spectral signatures (e.g. acoustic spectral), and enable significantly improved efficient scheduling of wireless ISAC base stations.

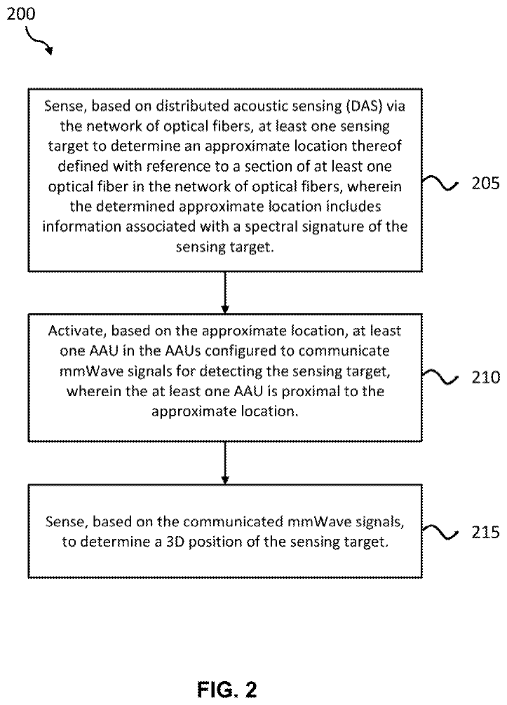

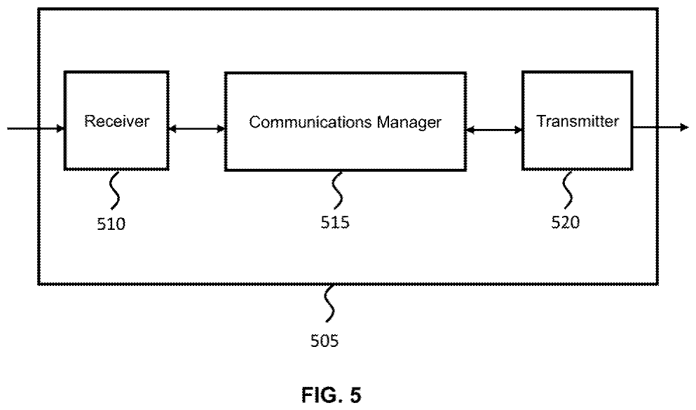

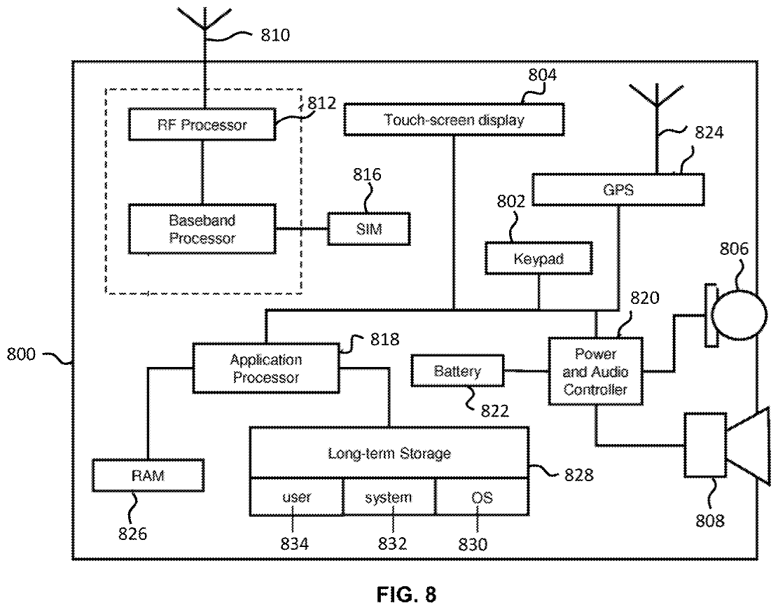

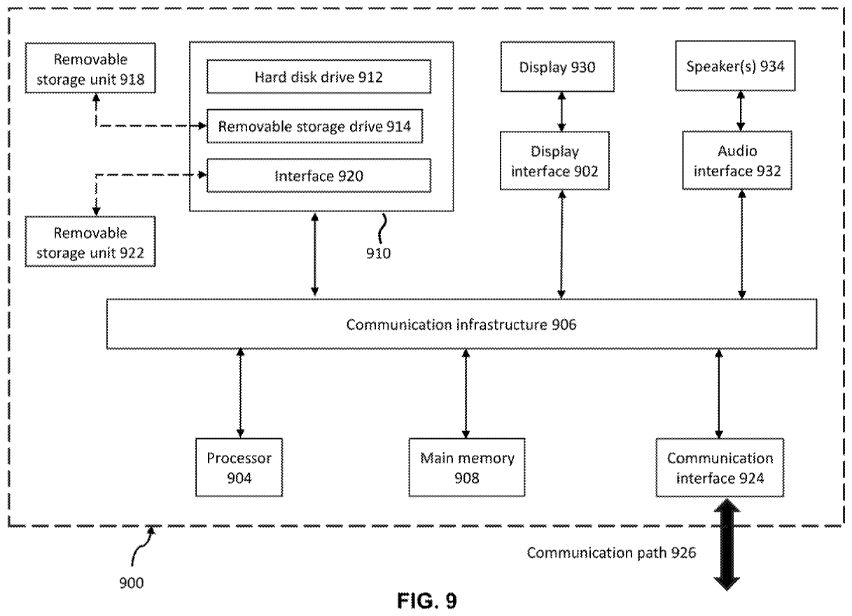

FIG. 2 is a flowchart illustrating a method 200 at a CO for detecting and/or tracking sensing targets, in accordance with aspects of the present disclosure. In this case, the CO is configured to operate a C-RAN adapted for ISAC, and the C-RAN includes a distribution of AAUs coupled via a network of optical fibers. The operations of method 200 may be implemented by a computing device, or its components. For example, the operations of method 200 may be performed by a communications manager as described with reference to FIGS. 5-7. In some examples, a computing device may execute a set of instructions to control the functional elements of the computing device to perform the functions described below. Additionally or alternatively, a computing device may perform aspects of the functions described below using special-purpose hardware (e.g. an ASIC). Exemplary structure/setup of components for such a computing device are discussed below with reference to FIGS. 8-9.

It is to be appreciated that the AAUs may be configured for 5G NR and/or 6G wireless communications. Additionally or alternatively, each AAU in the AAUs may be arranged with mmWave PAs.

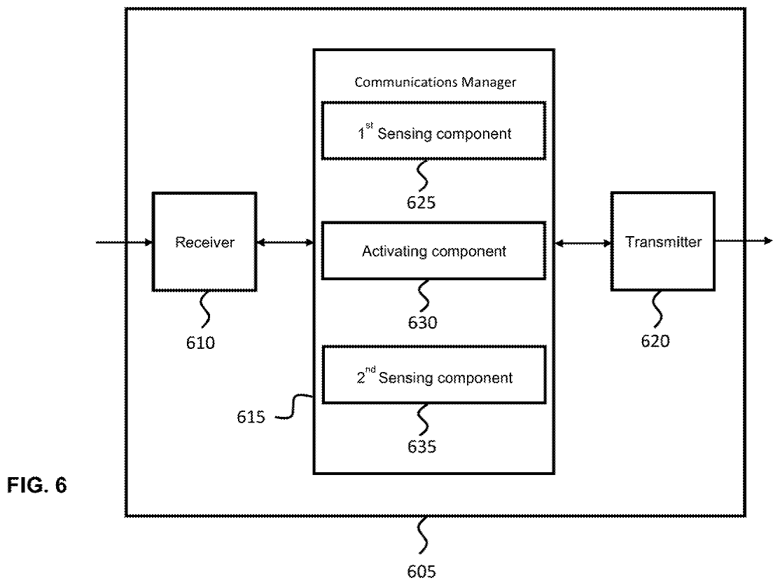

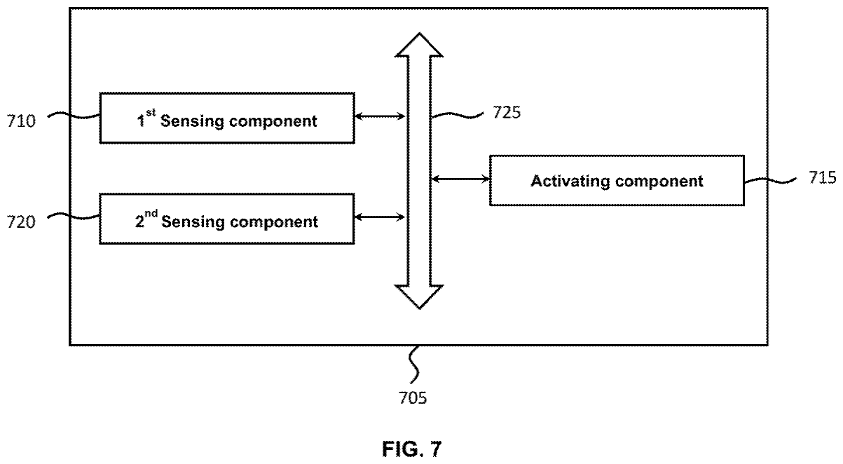

At 205, method 200 may comprise: sensing, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target. The operations of 205 may be performed according to the methods described herein. In some examples, aspects of the operations of 205 may be performed by a 1^{st} sensing component (installed in a computing device) as described with reference to FIGS. 6-7.

The determined approximate location may be represented as one-dimensional (1D) information. Moreover, in some examples, the spectral signature of the sensing target may include an acoustic spectral of the sensing target. In some instances, the at least one sensing target may also include multiple sensing targets.

The DAS may be configured based on phase-sensitive optical time-domain reflectometry (φ-OTDR). The DAS may include linear frequency modulated (LFM) DAS (LFM-DAS) sensing.

At 210, method 200 may comprise: activating, based on the approximate location, at least one AAU in the AAUs configured to communicate mmWave signals for detecting the sensing target, wherein the at least one AAU is proximal to the approximate location. The operations of 210 may be performed according to the methods described herein. In some examples, aspects of the operations of 210 may be performed by an activating component as described with reference to FIGS. 6-7.

At 215, method 200 may comprise: sensing, based on the communicated mmWave signals, to determine a 3D position of the sensing target, wherein the approximate location and the 3D position collectively permit distinguishing and detecting of the sensing target. The operations of 215 may be performed according to the methods described herein. In some examples, aspects of the operations of 215 may be performed by a 2^{nd} sensing component (installed in a computing device) as described with reference to FIGS. 6-7.

Additionally or alternatively, for determining the 3D position of the sensing target, the least one AAU may comprise a first AAU configured to transmit the mmWave signals, and a second AAU configured to receive the transmitted mmWave signals. The mmWave signals may be transmitted in a scanning range of substantially 5° by 5°. The first AAU is configured with a transmit phased array (Tx-PA) to transmit mmWave signals, while the second AAU is configured with a receive phased array (Rx-PA) to receive mmWave signals.

The first AAU may be configured to control an angle of departure (AOD) of the mmWave signals transmitted at (and towards) the sensing target, whereas the second AAU may be configured to estimate an angle of arrival (AOA) of mmWave signals received at the second AAU, in which the received mmWave signals are the transmitted mmWave signals reflected by the sensing target. That is, the transmitted mmWave signals that are reflected by the sensing target form those mmWave signals being received at the second AAU. In some implementations, the AOA may be estimated with one of: (a). minimum variance distortion-less response (CAPON); (b). iterative adaptive approach (IAA); and (c). multiple signal classification (MUSIC).

Notwithstanding, in some examples, the at least one AAU may be configured with both the Tx-PA and the Rx-PA. That is, the Tx-PA and the Rx-PA are arranged to be collocated in the at least one AAU. In this case, the at least one AAU is configured to transmit the mmWave signals at the sensing target, and to also receive mmWave signals that are reflected by the sensing target.

In some implementations, the operations of method 200 may be programmed into, and stored as corresponding computer-readable code that is executable by a computing device located at the CO.

### Features of Proposed ISAC System

The proposed ISAC system effectively enhances ISAC by collectively utilizing optical fiber front-hauls, and distributed PA antennas to enable joint fiber-wireless sensing. Some distinguishing features of the proposed ISAC system are explained below:

Feature (1): Optical fiber front-haul is used to interconnect distributive wireless antennas (i.e. the phased arrays (PAs)), effectively integrating multiple smaller ISAC systems into an extensive sensing network, thereby significantly extending the sensing coverage area. This capitalizes on the inherent advantages of the fiber connectivity, in which multiple remote antennas are centrally coordinated. This setup transforms smaller, localized ISAC systems into an extensive, scalable network capable of covering vast urban areas with uniform performance.

Feature (2): Assuming the layout of the optical fibers deployed for the front-haul, and the positions of the distributive wireless antennas are prior known, optical-fiber sensing (i.e. DAS) may instantaneously provide coarse localization of sensing targets within a small region defined with reference to a section of at least one optical fiber in the deployed network of optical fibers. Consequently, wireless antenna(s) located/situated closest to the identified region may direct one or more beams towards the sensing targets to perform detailed 3D sensing. Hence, DAS and mmWave PAs cooperate synergistically such that DAS instantly provides coarse mapping of possible sensing targets with reference to the known layout of the optical fibers (by pinpointing a small region where events occur), whereas nearest wireless antenna(s) may subsequently refine location of the sensing targets via high-resolution 3D sensing.

This approach may confer some advantages: (a). It requires activating only a subset of wireless antennas (from amongst the distributive wireless antennas) near a target area (identified through DAS), thereby enhancing sensing efficiency and reducing resource overheads (since those wireless antennas used for sensing are used also for the usual communications); and (b). Coarse localization may significantly reduce the scanning range (for transmitting the mmWave signals for sensing) from 180°×180° to about only 5°×5°, thus decreasing the scanning time by a factor of over 1000 (i.e. mmWave scanning may potentially be accelerated by more than three orders of magnitude). For completeness, it is to be appreciated there is an inherent latency associated with (mmWave) beam steering and target detection, since the scanning rate of a mmWave phased array is relatively slow (e.g. typically around 10 μs/beam).

Feature (3): Wireless sensing may conveniently identify 3D positions of sensing targets, thereby complementing the intrinsically one-dimensional information provided by DAS. In return, DAS may provide wireless sensing with acoustic information, enabling potential event classification through frequency-domain analysis, based on spectral signatures associated with the sensing targets (e.g. a phone, a drone, or the like).

Feature (4): The proposed ISAC system utilizes existing communication signals (e.g. mmWave signals) for sensing purposes without necessitating dedicated sensing channels, thus enabling seamless integration into existing state-of-the art communication networks, which enables faster, larger-scale and non-invasive surveillance of sensing targets, thereby facilitating improved development of future smart cities and low-altitude economy.

### Alternatives

Discussions on alternative approaches or configurations for the proposed ISAC system to achieve comparable functionalities are set out below.

For feature (1), instead of using optical fibers for the front-haul, it is envisaged that free-space optical (FSO) links may be used for extreme scenarios, although FSO links could be more susceptible to environmental factors and thus reduce reliability for detection of sensing targets. Another alternative is to use microwave or millimeter-wave wireless backhaul for connecting the distributed wireless antennas, but this may compromise the long-range coverage and the low cost of fiber-based solutions.

For feature (2), an alternative to relying on prior knowledge of the layout of the optical fibers is to incorporate machine-learning-based localization in both the fiber and wireless domains, although this may require extensive offline training and could potentially increase computational overhead. The same scanning-size reduction may also be achieved by employing more advanced beam-steering arrays, or meta-material reflectors that are able to switch beams faster, although commercial availability of such devices may be limited.

For feature (3), it is possible to combine fiber-optic sensors with other sensor types (e.g. infrared cameras) to gather complementary 2D or 3D data of sensing targets.

For feature (4), dedicated low-complexity wideband signals may alternatively be introduced for sensing, but this may likely increase costs or complexity for the proposed ISAC system.

### Ka-Band Experimental Setup and ISAC Methods

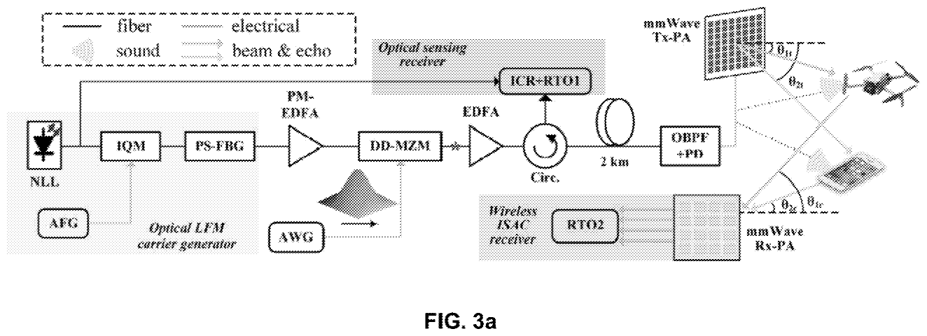

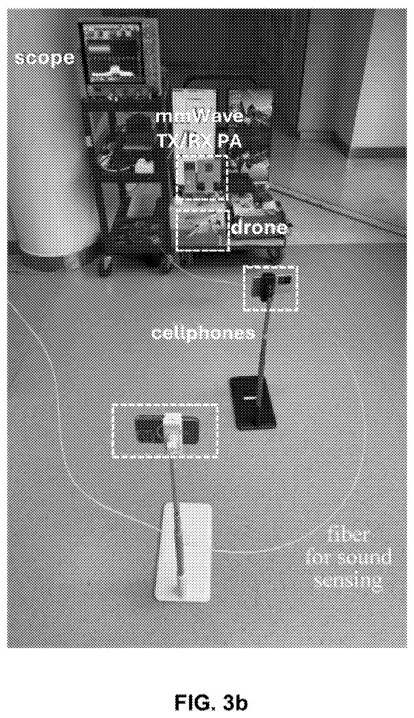

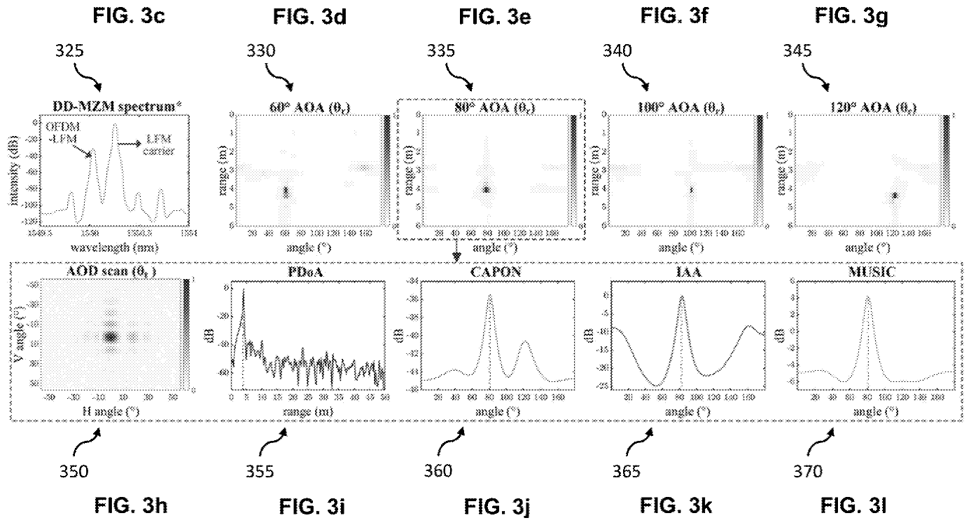

According to aspects of the present disclosure, FIG. 3a is an example mmWave fiber-wireless ISAC setup 300 for detecting and/or tracking sensing targets, and FIG. 3b is an example photonic-aided mmWave platform 320 used in the ISAC setup 300 of FIG. 3a.

FIGS. 3c to 3l are respective calibration of results 325, 330, 335, 340, 345, 350, 355, 360, 365, 370 obtained from the ISAC setup 300 of FIG. 3a using different algorithms, in accordance with aspects of the present disclosure.

As depicted in FIG. 3a, OFDM symbols are optically generated in a laboratory setting to test the ISAC setup 300. The OFDM symbols are then transmitted to the photonic-aided mmWave platform 320 (in FIG. 3b) which is arranged to be located in the corridor of a building via a 2-km extended optical fiber. To enable LFM-DAS sensing, an LFM carrier signal is transmitted to a dual-drive Mach-Zehnder modulator (DD-MZM), which is configured to be driven by an arbitrary waveform generator (e.g. AWG, Keysight M8196A). By adjusting the bias point, both an LFM carrier and an OFDM-LFM signal are generated, as illustrated the result 325 in FIG. 3c. The frequency interval between the LFM carrier and the OFDM-LFM symbol produces a 1-GHz bandwidth signal at 28-GHz, without chirps over the remote photodiode. Simultaneously, the LFM carrier signal generates Rayleigh Backscattering (RBS) for pulse-compression DAS demodulation. After bandpass filtering and amplification, the electrical mmWave signal is sent to an 8×8 transmit phased array (Tx-PA) operating at 28-GHz (Ka-band). The generated OFDM symbols are radio transmitted into free space and reflected back to a 4×4 receive phased array (Rx-PA), which is co-located with the Tx-PA in this case. The Rx-PA, with its four phase-shifted outputs, captures and down-converts the radio OFDM signal, which is then fed into a real-time oscilloscope (e.g. Keysight MSOS404A) for subsequent receiver digital signal processing (DSP).

Since the mmWave platform 320 may still experience circuit delays and multiple input multiple output (MIMO) signal skew even after clock synchronization, it is necessary to calibrate the accuracy of ranging and angle of arrival (AOA) estimation beforehand. The calibration process may involve the following steps: (1). scanning the AOD; (2). ranging; and (3). AOA estimation, following the same procedure as in the experiment. To correct errors in the ranging and angle estimation, the Rx-PA is positioned at the same range (e.g. 4 metres) from the Tx-PA. As depicted by the results 330, 335, 340, 345 in FIGS. 3d-3g, range-AOA diagrams are obtained by rotating the Tx-PA at different angles, while maintaining the same range, and these diagrams are used for calibration.

Taking an example of AOA at 80°, the Tx-PA scans within ±60° along the horizontal and vertical axes, with a beam width of 10°. To calibrate, the maximum receiver signal strength (RSS) in each direction is identified (as shown by the result 350 in FIG. 3h). This indicates the Tx-PA beam aligns with the line connecting the Tx-PA and the receiving object. The range is then estimated using the phase difference of arrival (PDoA) of OFDM subcarriers, as demonstrated by the result 355 in FIG. 3i. Since the PDoA relies on channel estimation, and the number of subcarriers and the bandwidth of the OFDM signal are 1024 and 1 GHz, respectively, the calculated ranging resolution is approximately 0.3 metres (i.e. 1.5 metres for round-trip). For AOA estimation, three different algorithms are compared: minimum variance distortion-less response (CAPON), iterative adaptive approach (IAA), and multiple signal classification (MUSIC). As shown by the results 360, 365, 370 in FIG. 3j-3l, all the three algorithms accurately measure the AOA at 80°, after calibrating the skew between outputs using the oscilloscope. For the purpose of the present disclosure, the MUSIC algorithm is adopted for subsequent experiments due to its suitability for measuring multiple objects.

### Results and Discussions

In this section, it is discussed how DAS and mmWave sensing may complement each other to achieve more efficient and multi-object aliasing free sensing. A 5-metres-long single-mode fiber (SMF) was deployed around the devices under test (DUT), and the SMF is firmly secured to the floor. Two (i.e. first and second) scenarios are studied:

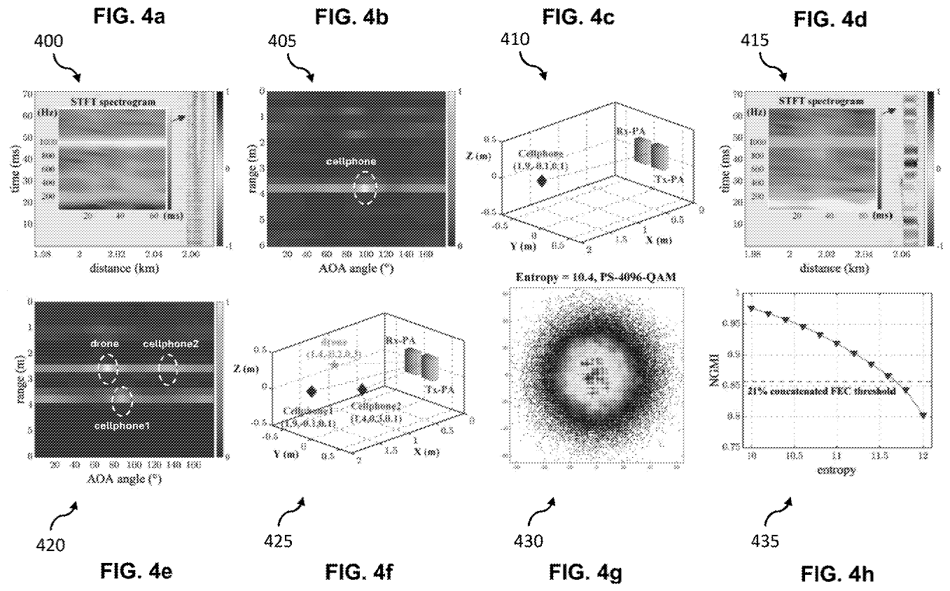

In the first scenario, a vibrating object is located near the RAN. A mobile phone playing 1-kHz music is placed approximately 2 meters away from the Tx-PA/Rx-PA to simulate a vibrating object. The optical LFM signal in the setup has a sweep bandwidth of about 100 MHz, resulting in a resolution of 5 meters after applying the rotated vector sum (RVS) method. The result 400 in FIG. 4a, and its inset show a detected vibration event along the SMF, and its corresponding short-time Fourier transform (STFT) spectrogram. Although the vibration signal appears weak due to the absence of structural amplifications like those described, the STFT spectrogram still reveals a 1-kHz vibration at about 2.06 km corresponding to the location of the mobile phone. However, DAS may only identify which section of the SMF is experiencing a vibration of certain frequency and cannot provide detailed 3D spatial information.

To address the issue, DAS in the CO triggers (and activates) an AAU located closest to the identified section of the SMF, and the AAU then scans the area and provides the 3D spatial information of the detected event. DAS then triggers the mmWave platform 320, which provides the complete 3D localization information (of the vibrating object) using AOD-range-AOA. The range-AOA diagram and the reconstructed 3D position are shown in the results 405, 410 of FIGS. 4b and 4c, respectively. With the assistance of DAS, in practice, the PA no longer needs to scan the entire angles (H and V depicted in FIG. 4g); instead, the scanning may dramatically be reduced from a full 180°×180° coverage to only a few degrees, such as 5°×5°, thereby reducing the scanning time by a factor of (180/5)² being 1296, which is more than a factor of 1000.

In the second scenario, multiple objects detection is to be performed in a small space. In this case, a drone (e.g. a DJI Mini 4 Pro) is introduced, and another mobile phone is positioned at a different angle and approximately 1.5 meters away from the Tx-PA/Rx-PA, and the mobile phone is playing also 1-kHz music. The DAS waterfall plot 415 in FIG. 4d clearly indicates a distinct soundtrack at the same location but fails to provide further details due to multiple-object aliasing. The inset STFT spectrogram shows that the primary frequency components have shifted to 0-220 Hz, corresponding to the blade passing frequency of the small drone. The result 420 in FIG. 4e illustrates that, for a specific AOD, the range-AOA diagram reveals the presence of three distinct objects. After completing the AOD-ranging-AOA process, the reconstructed 3D positions are depicted in the result 425 in FIG. 4f, which align well with the actual object placement. This case illustrates that when DAS struggles to distinguish the number of objects (particularly if they share the same vibration frequency), mmWave sensing may provide the 3D spatial distribution of the multiple objects and overcome the inherent limitations of DAS.

A space channel with two paths was constructed, in which one path is configured to reflect off the wall. A 1-GHz 1024-subcarrier probabilistic shaping (PS-4096-QAM-OFDM) OFDM signal is transmitted with entropy ranging from 10 to 12. Due to the use of a cyclic prefix (CP), the recovered constellation is unaffected by the multi-path, as shown by the result 430 in FIG. 4g. The normalized generalized mutual information (NGMI) is measured as a function of entropy and is shown by the result 435 in FIG. 4h. The results indicate that an entropy of 11.6 still exceeds the forward error correction (FEC) threshold, achieving a net-rate spectral efficiency of: [11.6−(1−0.826)*Log₂4096] Being 9.51 Bit/s/hz.

Aspects of the present disclosure relates to an integrated 3D sensing and communication system, via a C-RAN structure, without using dedicated sensing channels. It is afore demonstrated that simultaneous PS-4096QAM-OFDM wireless transmission and multi-object aliasing-free sensing with 3D localization of sensing targets (e.g. drones and smartphones) may be achieved. The proposed ISAC system successfully achieves simultaneous high-speed wireless communication and aliasing-free multi-object sensing at ultra-high scanning rates, enabling effective detecting and tracking diverse objects, including drones and smartphones. So, the proposed ISAC system may enable faster, larger-scale and non-invasive surveillance, thereby facilitating development of future smart cities and low-altitude economy.

One potential application for the proposed ISAC system is intrusion detection. For example, the disclosed method 200 of FIG. 2 may be used for detecting and localizing drones illegally flying in restricted regions. DAS, based on optical sensing, may detect the faint sound generated by the drones and analyze its frequency, while wireless sensing (based on using mmWave signals) may then localize the source of the detected sound (generated by the drones).

Another potential application for the proposed ISAC system is for ISAC operations in 6G-based networks, since ISAC has been identified as a main usage scenario for 6G-based networks. A cellular network comprises both an optical fiber network that connects a core network (CN) and base stations therein, and a wireless network that connects the base stations and users. The disclosed method 200 of FIG. 2 may permit ISAC in both the optical fiber network and the wireless network in 6G-based systems.

FIG. 5 is block diagram of a device 505 for detecting and/or tracking sensing targets, in accordance with aspects of the present disclosure. The device 505 may be an implementation of the mmWave fiber-wireless ISAC setup 300 of FIG. 3a. The device 505 may be arranged at a centralized office (CO), wherein the CO is configured to operate a C-RAN that is adapted for ISAC, and the C-RAN includes a distribution of AAUs coupled via a network of optical fibers. The device 505 may include a receiver 510, a communications manager 515, and a transmitter 520. The communications manager 515 can be implemented, at least in part, by one or both of a modem and a processor. Each of these components may be in communication with one another (e.g. via one or more buses).

The receiver 510 may receive information such as packets, user data, or control information associated with various information channels (e.g. control channels, data channels, or the like). Information may be passed on to other components of the device 505. The receiver 510 may be an example of aspects of the Rx-PA. The receiver 510 may utilize a single antenna or a set of antennas (e.g. for MIMO communications).

The communications manager 515 may (perform the following in chronological order):
sense, based on DAS via the network of optical fibers, at least one sensing target to determine an approximate location thereof defined with reference to a section of at least one optical fiber in the network of optical fibers, wherein the determined approximate location includes information associated with a spectral signature of the sensing target;
activate, based on the approximate location, at least one AAU in the AAUs configured to communicate mmWave signals for detecting the sensing target, wherein the at least one AAU is proximal to the approximate location; and
sense, based on the communicated mmWave signals, to determine a 3D position of the sensing target, wherein the approximate location and the 3D position collectively permit distinguishing and detecting of the sensing target.

The transmitter 520 may transmit signals generated by other components of the device 505. For example, the transmitter 520 may be an example of aspects of the Tx-PA. The transmitter 520 may utilize a single antenna or a set of antennas (e.g. for MIMO communications).

FIG. 6 is block diagram of a device 605 for detecting and/or tracking sensing targets, in accordance with aspects of the present disclosure. The device 605 may be an implementation of the mmWave fiber-wireless ISAC setup 300 of FIG. 3a. The device 605 may include a receiver 610, a communications manager 615, and a transmitter 630. The communications manager 615 can be implemented, at least in part, by one or both of a modem and a processor. Each of these components may be in communication with one another (e.g. via one or more buses).

The receiver 610 may receive information such as packets, user data, or control information associated with various information channels (e.g. control channels, data channels, or the like). Information may be passed on to other components of the device 605. The receiver 610 may be an example of aspects of the Rx-PA. The receiver 510 may utilize a single antenna or a set of antennas (e.g. for MIMO communications).

The communications manager 615 may include a 1^{st} sensing component 625, an activating component 630, and a 2^{nd} sensing component 635.

The 1^{st} sensing component 625 may sense, based on DAS via the network of optical fibers, at least one sensing target to determine an approximate location thereof defined with reference to a section of at least one optical fiber in the network of optical fibers, wherein the determined approximate location includes information associated with a spectral signature of the sensing target.

The activating component 630 may activate, based on the approximate location, at least one AAU in the AAUs configured to communicate mmWave signals for detecting the sensing target, wherein the at least one AAU is proximal to the approximate location,

The 2^{nd} sensing component 635 may sense, based on the communicated mmWave signals, to determine a 3D position of the sensing target, wherein the approximate location and the 3D position collectively permit distinguishing and detecting of the sensing target.

The transmitter 620 may transmit signals generated by other components of the device 605. For example, the transmitter 620 may be an example of aspects of the Tx-PA. The transmitter 620 may utilize a single antenna or a set of antennas (e.g. for MIMO communications).

FIG. 7 is a block diagram of a communications manager 705 for detecting and/or tracking sensing targets, in accordance with aspects of the present disclosure. The communications manager 705 may be an example of aspects of a communications manager 515 (at FIG. 5), or a UE communications manager 615 (at FIG. 6) described herein. It is to be appreciated that the communications manager 705 may be executed by a computer device 800, 900, as depicted in FIGS. 8-9, or its components. The communications manager 705 may include a 1^{st} sensing component 710, an activating component 715, and a 2^{nd} sensing component 720. Each of these components may communicate 725, directly or indirectly, with one another (e.g. via one or more buses).

The 1^{st} sensing component 710 may sense, based on DAS via the network of optical fibers, at least one sensing target to determine an approximate location thereof defined with reference to a section of at least one optical fiber in the network of optical fibers, wherein the determined approximate location includes information associated with a spectral signature of the sensing target.

The activating component 715 may activate, based on the approximate location, at least one AAU in the AAUs configured to communicate mmWave signals for detecting the sensing target, wherein the at least one AAU is proximal to the approximate location,

The 2^{nd} sensing component 720 may sense, based on the communicated mmWave signals, to determine a 3D position of the sensing target, wherein the approximate location and the 3D position collectively permit distinguishing and detecting of the sensing target.

In some examples, each of the components 710, 715, 720 in the communications manager 705 may be realized as specific hardware modules (e.g. ASICs) to perform those same associated operations. Notwithstanding, implementation of said components 710, 715, 720 may optionally be realized via a mix of hardware and software modules, as desired.

FIG. 8 is a schematic diagram of an exemplary (first) computing device 800 that may be utilized for executing and performing method 200 of FIG. 2, in accordance with aspects of the present disclosure.

The computing device 800 may comprise a keypad 802, a touch-screen 804, a microphone 806, a speaker 808 and an antenna 810. The computing device 800 may be operated by a user to perform a variety of different functions/tasks, for example, making a telephone call, sending an SMS message, browsing the Internet, sending emails, providing satellite navigation, or the like.

The computing device 800 may comprise hardware to perform communication functions (e.g. telephony, or data communication), together with an application processor and corresponding supporting hardware to enable the computing device 800 to establish other functions, for example, messaging, Internet browsing, email functions or the like. The communication hardware may include a radio frequency (RF) processor 812, which provides an RF signal to the antenna 810 for the transmission of data signals, and the receipt therefrom. A baseband processor 814 may be provided, which provides signals to, and receives signals from the RF processor 812. The baseband processor 814 may also interact with a subscriber identity module (SIM) 816, as known in the art. The communication subsystem enables the computing device 800 to communicate via a number of different communication protocols including 3G, 4G, 5G, New Radio (NR), GSM, WiFi, Bluetooth™ and/or CDMA. The communication subsystem of the computing device 800 is beyond the scope of the present disclosed subject matter.

The keypad 802 and the touch-screen 804 are controlled by an application processor 818. A power and audio controller 820 is provided to supply power from a battery 822 to the communication subsystem, the application processor 818, and the other hardware. The power and audio controller 820 also controls input from the microphone 806, and audio output via the speaker 808. There may also be provided a global positioning system (GPS) antenna and associated receiver element 824, which is controlled by the application processor 818 and is capable of receiving a GPS signal for use with a satellite navigation functionality of the computing device 800.

Various different types of memory may be provided in the computing device 800 to supplement operations of the application processor 818. The computing device 800 may include Random Access Memory (RAM) 826 coupled to the application processor 818 into which data and program code may be written and read from. Code stored in RAM 826 may be executed by the application processor 818 from RAM 826. RAM 826 represents a form of volatile memory of the computing device 800.

The computing device 800 may further be provided with a non-volatile (long-term) storage 828 coupled to the application processor 818. The storage 828 may logically be divided into three partitions: an operating system (OS) partition 830, a system partition 832, and a user partition 834. The storage 828 may represent a non-volatile memory of the computing device 800.

In the present example, the OS partition 830 may include firmware of the computing device 800, which includes an operating system. Other computer programs may also be stored in the storage 828, such as application programs (also referred to as apps), and the like. Particularly, application programs considered critical to functioning of the computing device 800, for example, in the case of a smartphone, communications applications and the like, are typically stored in system partition 832. The application programs stored on the system partition 832 typically may be programmed in the computing device 800 in its factory setting.

Application programs subsequently added and installed on the computing device 1600 by the user may typically be stored in the user partition 834.

The various functional components illustrated in FIG. 8 may alternatively be collocated into a single component. For example, the storage 828 may comprise NAND flash, NOR flash, a hard disk drive or a combination of these.

FIG. 9 is a schematic diagram of an exemplary (second) computing device 900 that may be utilized for executing and performing method 200 of FIG. 2, in accordance with aspects of the present disclosure. The following description of the computing device 900 is provided by way of example only and is not intended to be limiting.

As depicted in FIG. 9, the example computing device 900 may include a processor 904 for executing software routines. While only a single processor is shown for brevity, the computing device 900 may also be configured as a multi-processor system (i.e. includes multiple processors). The processor 904 is coupled to a communication infrastructure 906 for communication with other components of the computing device 900. The communication infrastructure 906 may include, for example, a communications bus, a crossbar network, or a network.

The computing device 900 further includes a main memory 908, such as a random-access memory (RAM), and a secondary memory 910. The secondary memory 910 may include, for example, a hard disk drive 912 and/or a removable storage drive 914, which may include a floppy disk drive, a magnetic tape drive, an optical disk drive, or the like. The removable storage drive 914 reads from and/or writes to a removable storage unit 918, as known in the art. The removable storage unit 918 may include a floppy disk, magnetic tape, optical disk, or the like, which is read by and/or written to by removable storage drive 914. As may be appreciated by skilled persons in the art, the removable storage unit 918 may further include a computer readable storage medium having stored therein computer executable program code instructions and/or data.

In other aspects, the secondary memory 910 may additionally or alternatively include other similar means for allowing computer programs or other instructions to be loaded into the computing device 900 for execution. Such means may include, for example, a removable storage unit 922 and an associated interface 920. Examples of a removable storage unit 922 and interface 920 may include a program cartridge and cartridge interface (e.g. such as that found in video game console devices), a removable memory chip (e.g. an EPROM or PROM) and associated socket, and other exemplary removable storage units 922 and interfaces 920, which may enable software programs and/or data to be transferred between the removable storage unit 922 and the computer device 900.

The computing device 900 also includes at least one communication interface 924. The communication interface 924 allows software programs and data to be transferred between computing device 900 and external devices, via a communication path 926. In various aspects, the communication interface 924 permits data to be transferred between the computing device 900 and a data communication network, such as a public data or private data communication network. The communication interface 924 may be used to exchange data between different computing devices 900 that may together form part of an interconnected computer network. Examples of a communication interface 924 may include a modem, a network interface (e.g. an Ethernet card), a communication port, an antenna with associated circuitry or the like. The communication interface 924 may be configured as wired or wireless. Software and data transferred via the communication interface 924 are in the form of signals, which can be electronic, electromagnetic, optical or other signals capable of being received by communication interface 924. These signals are provided to the communication interface via the communication path 926.

The computing device 900 further may include a display interface 902 configured to perform operations for rendering images to an associated display 930, and an audio interface 932 for performing operations for playing audio content via associated speaker(s) 934.

As used herein, the term “computer program product” may refer, in part, to the removable storage unit 918, the removable storage unit 922, a hard disk installed in the hard disk drive 912, or a carrier wave carrying software over the communication path 926 (e.g. via a wireless link, or a cable) to the communication interface 924. Computer readable storage media refers to any non-transitory tangible storage medium that provides recorded instructions and/or data to the computing device 900 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card or the like, whether or not such devices are internal or external of the computing device 1700. Examples of transitory or non-tangible computer readable transmission media that may also participate in the provision of software, application programs, instructions and/or data to the computing device 900 include radio or infra-red transmission channels as well as a network connection to another computer or networked device, and the Internet or Intranets including e-mail transmissions and information recorded on websites and the like.

The computer programs (also termed computer program code/instruction) are stored in the main memory 908 and/or the secondary memory 910. Computer programs may also be received via the communication interface 924. Such computer programs, when executed, enable the computing device 900 to perform one or more aspects of the present disclosure afore discussed. In various aspects of the present disclosure, the computer programs, which when executed, enable the processor 904 to perform aspect(s) of the present disclosure (e.g. method 200 of FIG. 2). Accordingly, such computer programs may represent controllers of the computer device 1700.

Software may be stored in a computer program product and loaded into the computing device 900, using the removable storage drive 914, the hard disk drive 912, or the interface 920. Alternatively, the computer program product may be downloaded directly onto the computer device 900, via the communication path 926. The software, when executed by the processor 904, causes the computing device 900 to perform aspects of the present disclosure.

It is to be understood that the computing device 900 in FIG. 9 is presented merely by way of example. Hence, in some aspects, one or more features of the computing device 900 may be omitted. Also, in other aspects, one or more features of the computing device 900 may be combined together, or collocated. Additionally, in some aspects, one or more features of the computing device 900 may be divided into one or more component parts.

It is to be appreciated that the elements illustrated in FIG. 9 may further function to provide means for performing the various functions of method 200 in FIG. 2, as described in accordance with aspects of the present disclosure. Also, the term “computing device” 800, 900 may include or may be referred to as a mobile device, a wireless device, a remote device, a handheld device, a tablet computer, a laptop computer, a computer server, a computer terminal, a blade server, among other examples. The computing device 800, 900 described herein may be able to communicate with various types of devices, such as other computing devices 800, 900 that may sometimes act as relays, or work together under configuration to function as a computer cluster for performing high-performance computing.

All of the methods described herein describe possible implementations, and that the operations and the steps may be rearranged or otherwise modified and that other implementations are possible. Further, aspects from two or more of the methods, if applicable, may appropriately be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (such as, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples”. The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but to be accorded the broadest scope consistent with the principles and novel features disclosed herein.

### EXAMPLES

The following examples are disclosed, in accordance with aspects of the present disclosure.

Example 1: A computer-implemented method at a centralized office (CO), wherein the CO is configured to operate a centralized radio access network (C-RAN) that is adapted for integrated sensing and communication (ISAC) and the C-RAN includes a distribution of active antenna units (AAUs) coupled via a network of optical fibers, the method comprises: sensing, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target; activating, based on the approximate location, at least one AAU in the AAUs configured to communicate millimeter-wave (mmWave) signals for detecting the sensing target, wherein the at least one AAU is proximal to the approximate location; and sensing, based on the communicated mmWave signals, to determine a 3-dimensional (3D) position of the sensing target, wherein the approximate location and the 3D position collectively permit distinguishing and detecting of the sensing target.

Example 2: The method of example 1, wherein the AAUs are configured for 5G New Radio (NR) and/or 6G wireless communications.

Example 3: The method of example 1, wherein each AAU in the AAUs is arranged with mmWave phased arrays (PAs).

Example 4: The method of example 1, wherein for determining the 3D position of the sensing target, the at least one AAU includes two AAUs comprising a first AAU configured to transmit the mmWave signals, and a second AAU configured to receive the transmitted mmWave signals.

Example 5: The method of example 4, wherein the mmWave signals are transmitted in a scanning range of substantially 5° by 5°.

Example 6: The method of example 4, wherein the first AAU is configured to control an angle of departure (AOD) of the mmWave signals transmitted at the sensing target; and wherein the second AAU is configured to estimate an angle of arrival (AOA) of mmWave signals received at the second AAU, the received mmWave signals being the transmitted mmWave signals reflected by the sensing target.

Example 7: The method of example 6, wherein the AOA is estimated with one of: a) minimum variance distortion-less response (CAPON); b) iterative adaptive approach (IAA); and c) multiple signal classification (MUSIC).

Example 8: The method of example 1, wherein the determined approximate location is represented as one-dimensional (1D) information.

Example 9: The method of example 1, wherein the DAS is configured based on phase-sensitive optical time-domain reflectometry (φ-OTDR).

Example 10: The method of example 1, wherein the DAS includes linear frequency modulated (LFM) DAS (LFM-DAS) sensing.

Example 11: The method of example 1, wherein the mmWave signals are in the form of orthogonal frequency division multiplexing (OFDM) communication signals.

Example 12: The method of example 11, wherein the OFDM communication signals are in the Ka-band.

Example 13: The method of example 1, wherein the spectral signature of the sensing target includes an acoustic spectral of the sensing target.

Example 14: The method of example 1, wherein the at least one sensing target includes a plurality of sensing targets.

Example 15: A computing device at a centralized office (CO), wherein the CO is configured to operate a centralized radio access network (C-RAN) that is adapted for integrated sensing and communication (ISAC) and the C-RAN includes a distribution of active antenna units (AAUs) coupled via a network of optical fibers, the device comprises: one or more memories having executable code; and one or more processors coupled to the one or more memories, and configured to execute the code to cause the device to: sense, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target; activate, based on the approximate location, at least one AAU in the AAUs configured to communicate millimeter-wave (mmWave) signals for detecting the sensing target, wherein the at least one AAU is proximal to the approximate location; and sense, based on the communicated mmWave signals, to determine a 3-dimensional (3D) position of the sensing target, wherein the approximate location and the 3D position collectively permit distinguishing and detecting of the sensing target.

Example 16: The computing device of example 15, wherein for determining the 3D position of the sensing target, the at least one AAU includes two AAUs comprising a first AAU configured to transmit the mmWave signals, and a second AAU configured to receive the transmitted mmWave signals.

Example 17: The computing device of example 16, wherein the mmWave signals are transmitted in a scanning range of substantially 5° by 5°.

Example 18: The computing device of example 16, wherein the first AAU is configured to control an angle of departure (AOD) of the mmWave signals transmitted at the sensing target; and wherein the second AAU is configured to estimate an angle of arrival (AOA) of mmWave signals received at the second AAU, the received mmWave signals being the transmitted mmWave signals reflected by the sensing target.

Example 19: The computing device of example 18, wherein the AOA is estimated with one of: a) minimum variance distortion-less response (CAPON); b) iterative adaptive approach (IAA); and c) multiple signal classification (MUSIC).

Example 20: A non-transitory computer-readable medium comprising executable code, which when executed by a processor of a computing device at a centralized office (CO), cause the processor to perform the method of any of examples 1-14.

What is claimed is:

1. A computer-implemented method at a centralized office (CO), wherein the CO is configured to operate a centralized radio access network (C-RAN) that is adapted for integrated sensing and communication (ISAC) and the C-RAN includes a distribution of active antenna units (AAUs) coupled via a network of optical fibers, wherein the method comprises:
sensing, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target;
activating, based on the approximate location, at least one AAU in the AAUs configured to communicate millimeter-wave (mmWave) signals for detecting the sensing target, wherein the at least one AAU is proximal to the approximate location; and
sensing, based on the communicated mmWave signals, to determine a 3-dimensional (3D) position of the sensing target,
wherein the approximate location and the 3D position collectively permit distinguishing and detecting of the sensing target.

2. The method of claim 1, wherein the AAUs are configured for 5G New Radio (NR) and/or 6G wireless communications.

3. The method of claim 1, wherein each AAU in the AAUs is arranged with mmWave phased arrays (PAs).

4. The method of claim 1, wherein for determining the 3D position of the sensing target, the at least one AAU includes two AAUs comprising a first AAU configured to transmit the mmWave signals, and a second AAU configured to receive the transmitted mmWave signals.

5. The method of claim 4, wherein the mmWave signals are transmitted in a scanning range of substantially 5° by 5°.

6. The method of claim 4, wherein the first AAU is configured to control an angle of departure (AOD) of the mmWave signals transmitted at the sensing target; and
wherein the second AAU is configured to estimate an angle of arrival (AOA) of mmWave signals received at the second AAU, the received mmWave signals being the transmitted mmWave signals reflected by the sensing target.

7. The method of claim 6, wherein the AOA is estimated with one of:
a) minimum variance distortion-less response (CAPON);
b) iterative adaptive approach (IAA); and
c) multiple signal classification (MUSIC).

8. The method of claim 1, wherein the determined approximate location is represented as one-dimensional (1D) information.

9. The method of claim 1, wherein the DAS is configured based on phase-sensitive optical time-domain reflectometry (φ-OTDR).

10. The method of claim 1, wherein the DAS includes linear frequency modulated (LFM) DAS (LFM-DAS) sensing.

11. The method of claim 1, wherein the mmWave signals are in the form of orthogonal frequency division multiplexing (OFDM) communication signals.

12. The method of claim 11, wherein the OFDM communication signals are in the Ka-band.

13. The method of claim 1, wherein the spectral signature of the sensing target includes an acoustic spectral of the sensing target.

14. The method of claim 1, wherein the at least one sensing target includes a plurality of sensing targets.

15. A computing device at a centralized office (CO), wherein the CO is configured to operate a centralized radio access network (C-RAN) that is adapted for integrated sensing and communication (ISAC) and the C-RAN includes a distribution of active antenna units (AAUs) coupled via a network of optical fibers, wherein the device comprises:
one or more memories having executable code; and
one or more processors coupled to the one or more memories, and configured to execute the code to cause the device to:
sense, based on distributed acoustic sensing (DAS) via the network of optical fibers, at least one sensing target to determine an approximate location thereof defined with reference to a section of at least one optical fiber in the network of optical fibers, wherein the determined approximate location includes information associated with a spectral signature of the sensing target;
activate, based on the approximate location, at least one AAU in the AAUs configured to communicate millimeter-wave (mmWave) signals for detecting the sensing target, wherein the at least one AAU is proximal to the approximate location; and
sense, based on the communicated mmWave signals, to determine a 3-dimensional (3D) position of the sensing target,
wherein the approximate location and the 3D position collectively permit distinguishing and detecting of the sensing target.

16. The computing device of claim 15, wherein for determining the 3D position of the sensing target, the at least one AAU includes two AAUs comprising a first AAU configured to transmit the mmWave signals, and a second AAU configured to receive the transmitted mmWave signals.

17. The computing device of claim 16, wherein the mmWave signals are transmitted in a scanning range of substantially 5° by 5°.

18. The computing device of claim 16, wherein the first AAU is configured to control an angle of departure (AOD) of the mmWave signals transmitted at the sensing target; and
wherein the second AAU is configured to estimate an angle of arrival (AOA) of mmWave signals received at the second AAU, the received mmWave signals being the transmitted mmWave signals reflected by the sensing target.

19. The computing device of claim 18, wherein the AOA is estimated with one of:
a) minimum variance distortion-less response (CAPON);
b) iterative adaptive approach (IAA); and
c) multiple signal classification (MUSIC).

20. A non-transitory computer-readable medium comprising executable code, which when executed by a processor of a computing device at a centralized office (CO), cause the processor to perform the method of claim 1.
